(19) United States
(12) Patent Application Publication
(10) Pub. No.: US 2025/0113244 A1
(43) Pub. Date: Apr. 3, 2025

(54) RELATIVE DELAY REQUIREMENT FOR MULTI-MODAL TRAFFIC

(71) Applicant: Lenovo (Singapore) Pte. Ltd., Singapore (SG)

(72) Inventors: Joachim Löhr, Wiesbaden (DE); Hossein Bagheri, Dearborn Heights, MI (US); Vijay Nangia, Woodridge, IL (US)

(21) Appl. No.: 18/900,456

(22) Filed: Sep. 27, 2024

Related U.S. Application Data
(60) Provisional application No. 63/586,258, filed on Sep. 28, 2023.

(51) Int. Cl. H04W 28/02; H04W 28/06

(52) U.S. Cl. CPC H04W 28/0268; H04W 28/06

(57) ABSTRACT

Various aspects of the present disclosure relate to receiving a traffic ID for a multi-modal (MM) traffic flow and initiating an MM timer associated with a first LCH based on an arrival of a first data packet of the first LCH, where the multi-modal traffic flow comprises a plurality of LCHs associated with a multi-model application and where the first LCH is associated with the traffic ID. Aspects of the present disclosure may relate to identifying an inter-dependent data packet set based on the traffic ID, where the inter-dependent data packet set comprises the first data packet and at least one second data packet of a second LCH associated with the traffic ID, and applying a relative delay requirement to the inter-dependent data packet set based on the MM timer.

### TECHNICAL FIELD

The present disclosure relates to wireless communications, and more specifically to techniques for applying a relative delay requirement for traffic of multi-modal (MM) applications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include means for receiving a traffic identifier (ID) for a MM traffic flow, wherein the multi-modal traffic flow comprises a plurality of logical channels (LCHs) associated with a multi-model application. The method and apparatuses described herein may include means for initiating an MM timer associated with a first LCH based on an arrival of a first data packet of the first LCH, where the first LCH is associated with the traffic ID. The method and apparatuses described herein may include means for identifying an inter-dependent data packet set based on the traffic ID, where the inter-dependent data packet set comprises the first data packet and at least one second data packet of a second LCH associated with the traffic ID. The method and apparatuses described herein may include means for applying a relative delay requirement to the inter-dependent data packet set based on the MM timer.

In some implementations, the method and apparatuses described herein may further include means for transmitting, to a UE, a traffic ID for a MM traffic flow, where the MM traffic flow comprises a plurality of LCHs associated with a MM application. The method and apparatuses described herein may include means for transmitting, to the UE, a configuration message for configuring a set of MM timers. The method and apparatuses described herein may include means for receiving, from the UE, a status message indicating a relative delay requirement of an inter-dependent data packet set based on a respective MM timer of the set of MM timers, where the inter-dependent data packet set is associated with the traffic ID.

### BRIEF DESCRIPTION OF THE DRAWINGS

FIG. 1 illustrates an example of a wireless communications system in accordance with aspects of the present disclosure.

FIG. 2 illustrates an example of a protocol stack showing different protocol layers in the UE and network in accordance with aspects of the present disclosure.

FIG. 3 illustrates an example of a network model for MM traffic at the UE in accordance with aspects of the present disclosure.

FIG. 4 illustrates an example of a timing diagram for enforcing a synchronization requirement for a multi-modal application in accordance with aspects of the present disclosure.

FIG. 5 illustrates another example of a timing diagram for enforcing a synchronization requirement for a multi-modal application in accordance with aspects of the present disclosure.

FIG. 6 illustrates an example of a medium access control (MAC) control element (CE) format for a multi-modal delay status report (MM-DSR) in accordance with aspects of the present disclosure.

FIG. 7 illustrates another example of a MAC CE format for a MM-DSR in accordance with aspects of the present disclosure.

FIG. 8 illustrates an example of a user equipment (UE) 800 in accordance with aspects of the present disclosure.

FIG. 9 illustrates an example of a processor 900 in accordance with aspects of the present disclosure.

FIG. 10 illustrates an example of a network equipment (NE) 1000 in accordance with aspects of the present disclosure.

FIG. 11 illustrates a flowchart of a method performed by a UE in accordance with aspects of the present disclosure.

FIG. 12 illustrates a flowchart of a method performed by a radio access network (RAN) entity in accordance with aspects of the present disclosure.

### DETAILED DESCRIPTION

Generally, the present disclosure describes systems, methods, and apparatuses for cell measurement and access to network energy saving cells. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

The next-generation NodeB (gNB) can take into account knowledge of protocol data unit (PDU) set delay when scheduling transmissions, e.g., by giving priority to transmissions close to their delay budget limit, and by not scheduling (e.g., UL) transmissions exceeding a PDU set delay budget (e.g., a data packet delay budget). The UE can also take advantage of such knowledge to save power by determining whether an uplink (UL) transmission (e.g., UL pose, or physical uplink shared channel (PUSCH)) corresponding to a transmission that exceeds its delay budget can be dropped. Additionally, this knowledge of PDU set delay allows the UE to avoid waiting for re-transmission of a physical downlink shared channel (PDSCH) transmission that will never occur (e.g., discontinuous reception (DRX) retransmission timers can be stopped). For downlink (DL) transmissions, it is assumed that the gNB is aware of the Remaining Delay Budget of the data pending for transmission, e.g., based on information provided by the session management function (SMF), and takes such knowledge into account in scheduling decisions.

For UL resource allocation, it would be necessary that the UE provides some assistance information regarding the remaining delay budget of the data pending in its buffer to the gNB. In some embodiments, the UE provides information on the remaining delay budget of the data for which UL resources are requested. Such assistance information is referred to as Delay Status report (DSR) reporting. Note that the PDU Set Delay Budget (PSDB) information provided to the RAN is insufficient to be aware of the remaining delay budget of the pending data in the UE.

Because the network (e.g., RAN) is not aware of the exact arrival time of UL data in the buffer, and hence also cannot be sure about the remaining (valid) time of data being pending in the buffer for transmission, the UE provides this information (e.g., remaining delay information) within the DSR reporting. In certain embodiments, a new (DSR) MAC CE may be introduced for XR-specific logical channel groups (LCGs), which includes the amount of data available for transmission and some remaining delay information associated with the data reported.

Furthermore, certain networks may support threshold-based DSR reporting, e.g., DSR reporting is triggered when the remaining delay of a PDU/PDU set is below a network-configured threshold. In certain embodiments, the threshold is configured per LCG. It is possible that the network may support configuring multiple thresholds for an LCG.

A multi-modal application may have strict synchronization requirements, e.g., multi-modal data may need to be delivered within a small relative delay (i.e., small time window). As used herein, a multi-modal application refers to an application that uses multiple interaction modes simultaneously. Multi-modal applications are prominent in extended reality (XR) environments. Multi-modal applications may use a combination of input and output modalities, e.g., to create a more complete user experience. Data generated and consumed by a multi-modal application is referred to as multi-modal data, and the corresponding network traffic is referred to as multi-modal traffic. Examples of multi-modal data may include (but are not limited to): audio data, video data, haptic data, sensor data, location/position data, and text.

To ensure timely delivery of multi-modal traffic flows, new techniques are described herein to consider the inter-dependencies of PDU set(s) of different LCHs/flow. In various embodiments, said techniques include timers, priority, and structure of MM-DSR design.

Aspects of the present disclosure are described in the context of a wireless communications system.

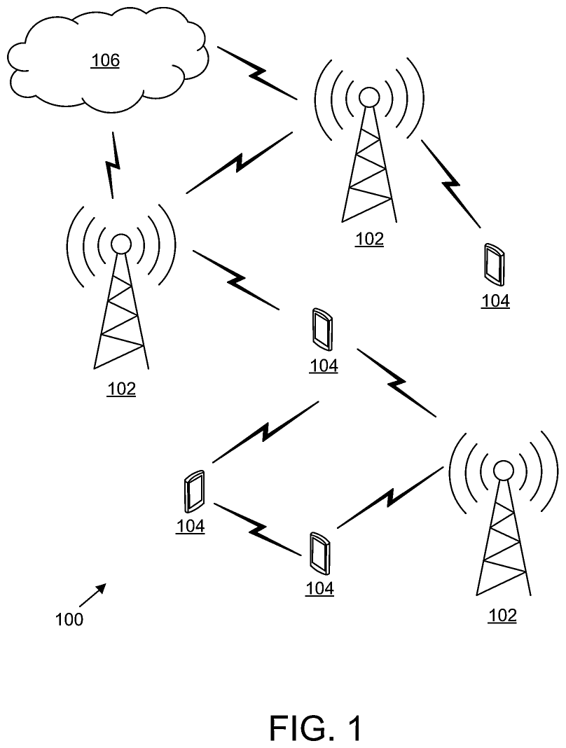

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a gNB, or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency domain multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Wireless communication in unlicensed spectrum (also referred to as “shared spectrum”) in contrast to licensed spectrum offer some obvious cost advantages allowing communication to obviate overlaying operator's licensed spectrum and rather use license free spectrum according to local regulation in specific geographies. From the Third Generation Partnership Project (3GPP) technology perspective, the unlicensed operation can be on the Uu interface (referred to as NR-U) or also on sidelink interface (e.g., SL-U).

For initial access, a UE 104 detects a candidate cell and performs DL synchronization. For example, the gNB (e.g., an embodiment of the NE 102) may transmit a synchronization signal and broadcast channel (SS/PBCH) transmission, referred to as a Synchronization Signal Block (SSB). The synchronization signal is a predefined data sequence known to the UE 104 (or derivable using information already stored at the UE 104) and is in a predefined location in time relative to frame/subframe boundaries, etc. The UE 104 searches for the SSB and uses the SSB to obtain DL timing information (e.g., symbol timing) for the DL synchronization. The UE 104 may also decode system information (SI) based on the SSB. Note that with beam-based communication, each DL beam may be associated with a respective SSB.

After performing DL synchronization and acquiring essential system information, such as the Master Information Block (MIB) and the System Information Block type 1 (SIB1), the UE 104 performs uplink (UL) synchronization and resource request by performing a random access procedure, referred to as “RACH procedure” by selecting and transmitting a preamble on the Physical Random Access Channel (PRACH). The PRACH preamble is transmitted during a RACH occasion, i.e., a predetermined set of time-frequency resources that are available for the reception of the PRACH preamble. Note that with beam-based communication, the UE 104 may select a certain DL beam and transmit the PRACH preamble on a corresponding UL beam. In such embodiments, there may be a mapping between SSB and RACH occasion, allowing the network to determine which beam the UE 104 has selected.

To complete the RACH procedure, after transmitting the PRACH preamble (also referred to as “Msg1”), the UE 104 monitors for a random-access response (RAR) message (also referred to as “Msg2”). The gNB transmits UL timing adjustment information in the RAR and may also schedule an UL resource, referred to as an initial uplink grant.

In 3GPP New Radio (NR), the gNB may transmit the maximum 64 SSBs and the maximum 64 corresponding copies of Physical Downlink Control Channel (PDCCH) and/or Physical Downlink Shared Channel (PDSCH) for delivery of SIB1 in high frequency bands (e.g., 28 GHz). This may cause significant network energy consumption even for a very low traffic load condition. According to 3GPP Technical Report (TR) 38.864 (v18.1.0), for network energy savings, on-demand SSB and/or SIB1 (SSB/SIB1) transmissions and a cell without SSB/SIB1 transmission were considered. When a cell does not transmit SSB/SIB1, for a UE to access the cell, the UE should obtain SI of the cell from other associated carriers/cells and synchronize from other associated carriers/cells. When a cell is in a long period of cell inactivity, a UE served by the cell can trigger SSB/SIB1 transmissions by sending a request to the cell.

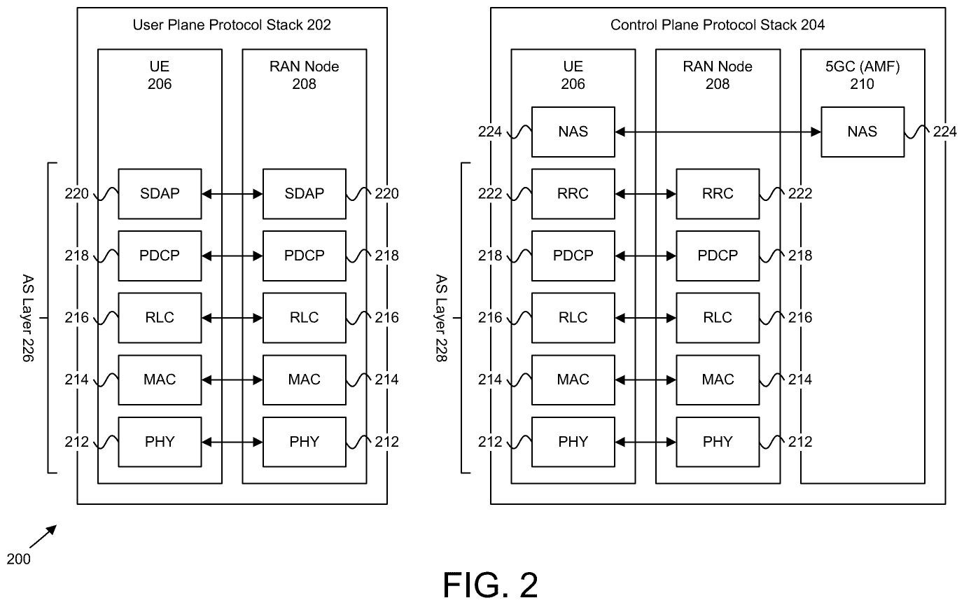

FIG. 2 illustrates an example of a protocol stack 200 in accordance with aspects of the present disclosure. While FIG. 2 shows a UE 206, a RAN node 208, and a 5G core network (5GC) 210 (e.g., comprising at least an AMF), these are representative of a set of UEs 104 interacting with an NE 102 (e.g., base station) and a CN 106. As depicted, the protocol stack 200 comprises a User Plane protocol stack 202 and a Control Plane protocol stack 204. The User Plane protocol stack 202 includes a physical (PHY) layer 212, a Medium Access Control (MAC) sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP layer 220, PDCP sublayer 218, RLC sublayer 216, and MAC sublayer 214. The Layer-3 (L3) includes the RRC layer 222 and the NAS layer 224 for the control plane and includes, e.g., an Internet Protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels to the RLC sublayer 216. The RLC sublayer 216 offers RLC channels to the PDCP sublayer 218. The PDCP sublayer 218 offers radio bearers to the SDAP sublayer 220 and/or RRC layer 222. The SDAP sublayer 220 offers QoS flows to the core network (e.g., 5GC). The RRC layer 222 provides for the addition, modification, and release of Carrier Aggregation and/or Dual Connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through logical channels. The MAC sublayer 214 therefore performs multiplexing and demultiplexing between logical channels and transport channels: the MAC sublayer 214 in the transmitting side constructs MAC PDUs (also known as Transport Blocks (TBs)) from MAC Service Data Units (SDUs) received through logical channels, and the MAC sublayer 214 in the receiving side recovers MAC SDUs from MAC PDUs received through transport channels.

The MAC sublayer 214 provides a data transfer service for the RLC sublayer 216 through logical channels, which are either control logical channels which carry control data (e.g., RRC signaling) or traffic logical channels which carry user plane data. On the other hand, the data from the MAC sublayer 214 is exchanged with the PHY layer 212 through transport channels, which are classified as UL or downlink (DL). Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP layer 240, RRC layer 222 and NAS layer 224) and a transmission layer in Multiple-Input Multiple-Output (MIMO) communication (also referred to as a “MIMO layer” or a “data stream”).

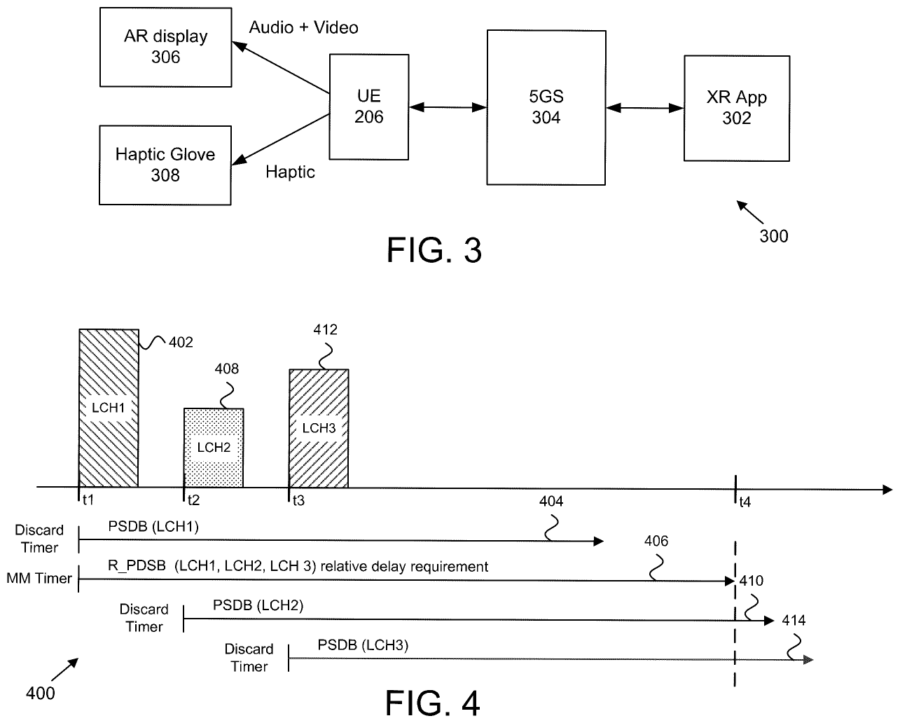

FIG. 3 illustrates an example of a network model 300 for MM traffic at the UE in accordance with aspects of the present disclosure. FIG. 3 illustrates a UE 206 interacting with an XR application 302 via a 5G system (5GS) 304. In various embodiments, the UE 206 is representative of a UE 104 interacting with a set of NEs 102 and CN entities. Moreover, the UE 206 may be communicatively coupled with an augmented reality (AR) display 306 and at least one haptic glove 308.

As depicted, the network model 300 for MM traffic at the UE 206 involves the 5GS 304 relaying data (e.g., XR traffic) between the UE 206 and the XR application 302. Additionally, in the downlink the UE 206 parses audio and video data from haptic data, sends the audio and video data to the AR display 306, and sends the haptic data to the at least one haptic glove 308. While not depicted in FIG. 3, in the uplink direction, the UE 206 may multiplex audio and video data with location/position data and send these data to the XR application 302.

PDU-Set Importance (PSI) may be considered for PDU set discarding in the presence of UL congestion. Therefore, in addition to the timer-based discard mechanism within a given PDCP entity, a PDCP discarding mechanism based on PSI may be implemented for XR communications.

The discarding mechanism based on the importance level (i.e., PSI) of a PDU set in the case of congestion has not been standardized. However, in certain implementations the network may control the PSI-based discarding at the UE at the presence of congestion. To be more specific, the network may explicitly order the UE to enable/disable PSI-based PDCP discarding, e.g., based on a detected congestion. In this implementation, the network is responsible for the detection of congestion and UE just obeys the network signalling.

In one embodiment, PSI-based discarding may be implemented as timer-based (Option A) or as threshold-based (Option B) discarding. When the network determines there is congestion and PSI-based discarding should be used, the network would indicate to the UE to apply PSI-based discarding via dedicated signaling.

According to Option A (Timer-based discarding), the UE sets a new discard timer value, i.e., a congestion timer value. These congestion timer values should be possible to configure with different values for different PSI levels (otherwise the mechanism would not be PSI based).

According to Option B (Threshold-based discarding), the UE directly drops PDU sets which have PSI below the threshold (e.g., as soon as they enter the buffer or directly when the PSI based discarding is activated in the UE).

Emerging use cases such as AR/VR and holographic communications encompass multiple simultaneous traffic flows where the arrival of packets must be synchronized. Incorporating the five senses in the XR experience necessitates more stringent end-to-end latency, jitter, and synchronization. Such services have even more stringent requirements on the wireless network since holographic flows require very tight synchronization of the five senses. Therefore, when designing NR enhancements to support extended reality (XR) applications, it is important to consider multimodal interaction techniques, which employ several human senses simultaneously. Multimodal interaction can transform how people communicate remotely, practice for tasks, entertain themselves, process information visualizations, and make decisions based on the provided information. For XR applications transmitted via a mobile communication system like NR the interactions between different input signals can be translated to some inter-dependencies between transmissions of different bearers/LCHs/flows, e.g., PDU set level QoS requirement(s) for XR and the dependency of different QoS flows are needed.

For an XR application, haptic/sensor data, video, and audio data may need to be delivered within a small relative delay. In addition, each of the data streams (video, sensor, etc.) should be delivered within its latency budget. A delay status report (DSR) can be triggered enabling gNB to assign resources to an un-delivered traffic flow getting close to its latency budget. This disclosure builds on the notion of DSR and provides solutions to ensure timely delivery of multi-modal traffic flows.

XR is an umbrella term for different types of realities including: Virtual reality (VR), Augmented reality (AR), and Mixed reality (MR). XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Virtual reality (VR) is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.

Augmented reality (AR) is when a user is provided with additional information or artificially generated items, or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.

Mixed reality (MR) is an advanced form of AR where some virtual elements are inserted into the physical scene with the intent to provide the illusion that these elements are part of the real scene.

Many of the XR and CG use cases are characterized by quasi-periodic traffic (with possible jitter) with high data rate in DL (i.e., video steam) combined with the frequent UL (i.e., pose/control update) and/or UL video stream. Both DL and UL traffic are also characterized by relatively strict packet delay budget (PDB).

The set of anticipated XR and Cloud Gaming (CG) services has a certain variety and characteristics of the data streams (i.e., video) may change “on-the-fly,” while the services are running over NR. Therefore, additional information on the running services from higher layers, e.g., the QoS flow association, frame-level QoS, PDU set-based QoS, XR-specific QoS, etc., may be beneficial to facilitate informed choices of radio parameters. It is clear that XR application awareness by UE and gNB would improve the user experience, improve the NR system capacity in supporting XR services, and reduce the UE power consumption.

An Application Data Unit (ADU) or PDU set is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices. A PDU set can be one or more I-slices, P-slices, I-frame, P-frame, or a combination of those.

A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient (e.g., in terms of satisfying XR service requirements for a greater number of UEs, or in terms of UE power saving) XR service delivery.

Various XR services require high data rate and low latency communications. An overview of XR services is available in 3GPP TR 38.835, while the service requirements are documented in 3GPP technical specification (TS) 22.261.

XR-Awareness relies on QoS flows, PDU Sets, Data Bursts and traffic assistance information (see 3GPP TS 23.501). Optional PDU Set QoS Parameters may be provided by the SMF to the gNB as part of the QoS profile of the QoS flow. Said parameters may include one or more of the following:

The PDU Set Delay Budget (PSDB) (e.g., as defined in TS 23.501) sets an upper bound for the duration between the reception time of the first PDU (at the UPF for DL, at the UE for UL) and the time when all PDUs of a PDU Set have been successfully received (at the UE in DL, at the UPF in UL). A QOS Flow is associated with only one PSDB, and when available, it applies to both DL and UL and supersedes the PDB of the QoS flow.

The PDU Set Error Rate (PSER) (e.g., as defined in 3GPP TS 23.501) sets an upper bound for a rate of non-congestion related PDU Set losses between RAN and the UE. A QoS Flow is associated with only one PSER, and when available, it applies to both DL and UL and supersedes the PER of the QoS flow. Note that a PDU set may be considered as successfully delivered only when all PDUs of a PDU Set are delivered successfully.

The PDU Set Integrated Handling Information (PSIHI) (e.g., as defined in TS 23.501) indicates whether all PDUs of the PDU Set are needed for the usage of PDU Set by application layer. Note that the PDU Set QoS parameters are common for all PDU Sets within a QoS flow.

In addition, the UPF can identify PDUs that belong to PDU Sets, and may determine PDU Set Information, which it sends to the gNB in the GPRS Tunnelling Protocol User Plane (GTP-U) header. The PDU Set Information may include one or more of the following: A) PDU Set Sequence Number; B) Indication of End PDU of the PDU Set; C) PDU Sequence Number within a PDU Set; D) PDU Set Size in bytes; E) PDU Set Importance (PSI), which identifies the relative importance of a PDU Set compared to other PDU Sets within the same QoS Flow.

In certain embodiments, traffic assistance information may also be provided by 5GC to the gNB, including one or more of: A) UL and/or DL Periodicity (provided via Time sensitive communications assistance information (TSCAI)); B) N6 Jitter Information (i.e. between UPF and Data Network) associated with the DL Periodicity (provided via TSCAI); and/or C) an indication of End of Data Burst in the GTP-U header of the last PDU in downlink.

In the uplink, the UE needs to be able to identify PDU Sets and Data Bursts dynamically, including PSI. How this is done is left up to UE implementation.

In order to enhance the scheduling of uplink resources for XR, an additional buffer status table may be used to reduce the quantization errors in buffer status report (BSR) reporting (e.g., for high bit rates), where the code points of this new table may follow a linear distribution. Additionally, the gNB may configure the buffer status table(s) that an LCG is eligible to use, and when there is more than one, the UE selects the table.

In order to enhance the scheduling of uplink resources for XR, delay knowledge of buffered data may be shared, consisting of remaining time, and distinguishing how much data is buffered for which delay. In certain embodiments, the delay information is reported together with BSR in a single MAC CE. In other embodiments, the delay information may be reported in a separate MAC CE.

In order to enhance the scheduling of uplink resources for XR, additional BSR triggering conditions may be implemented, to allow timely availability of buffer status information. Additionally, the scheduling may be enhanced by the reporting of uplink assistance information (jitter range and burst arrival time) per QoS flow by the UE via UE Assistance Information.

The latency requirement of XR traffic in RAN side (i.e., air interface) is modelled as packet delay budget (PDB). The PDB is a limited time budget for a packet to be transmitted over the air from a gNB to a UE.

For a given packet, the delay of the packet incurred in air interface is measured from the time that the packet arrives at the gNB to the time that it is successfully transferred to the UE. If the delay is larger than a given PDB for the packet, then, the packet is said to violate PDB, otherwise the packet is said to be successfully delivered.

As described in 3GPP technical report (TR) 26.926, the value of PDB may vary for different applications and traffic types, which can be 10-20 ms depending on the application.

In 5G, the arrival time of data bursts on the downlink can be quasi periodic, i.e., periodic with jitter. Some of the factors leading to jitter in burst arrival include varying server render time, encoder time, real-time transport protocol (RTP) packetization time, link between server and 5G gateway etc. 3GPP agreed simulation assumptions for XR evaluation model DL traffic arrival jitter using truncated Gaussian distribution with mean: 0 ms, std. dev: 2 ms, range: [−4 ms, 4 ms] (baseline), [−5 ms, 5 ms] (optional).

Applications can have a certain delay requirement on a PDU set, that may not be adequately translated into packet delay budget requirements. For example, if the PDU set delay budget (PSDB) is 10 ms, then PDB can be set to 10 ms only if all packets of the PDU set arrive at the 5G system at the same time. If the packets are spread out, then the PDU set delay budget is measured either in terms of the arrival of the first packet of the PDU set or the last packet of the PDU set. In either case, a given PSDB will result in different PDB requirements on different packets of the PDU set. It is observed that specifying the PSDB to the 5G system can be beneficial.

If the scheduler, and/or the UE is aware of delay budgets for a packet/ADU, the gNB can take this knowledge into account in scheduling transmissions, e.g., by giving priority to transmissions close to their delay budget limit, and by not scheduling (e.g., UL) transmissions; the UE can also take advantage of such knowledge to determine 1) if an UL transmission (e.g., physical uplink control channel (PUCCH) in response to PDSCH, UL pose, or PUSCH) corresponding to a transmission that exceeds its delay budget can be dropped (additionally, no need to wait for re-transmission of a PDSCH and no need to keep the erroneously received PDSCH in buffer for soft combining with a re-transmission that never occurs) or 2) how much of its channel occupancy time in case of using unlicensed spectrum can be shared with the gNB.

The remaining delay budget 1) for a DL transmission can be indicated to the UE in a DCI (e.g., for a packet of a video frame/slice/ADU) or via a MAC-CE (e.g., for an ADU/video frame/slice) and 2) for an UL transmission can be indicated to the gNB via an UL transmission such as uplink control information (UCI), PUSCH transmission, etc.

For the case that data of an LCG gets close to its maximum latency, the UE may use a new, separate MAC CE for DSR reporting, e.g., DSR reporting is not coupled with BSR reporting. This supports threshold-based DSR reporting, e.g., DSR reporting that is triggered when the remaining delay is below a network-configured threshold. In certain embodiments, the threshold is configured per LCG. In one embodiment, the network may support configuring multiple thresholds for an LCG.

When the PSIHI is set for a QoS flow, as soon as one PDU of a PDU set is known to be lost, the remaining PDUs of that PDU Set can be considered as no longer needed by the application and may be subject to discard operation at the transmitter to free up radio resources.

It cannot always be assumed that the remaining PDUs are not useful and can safely be discarded. Also, in case of Forward Error Correction (FEC), active discarding of PDUs when assuming that a large enough number of packets have already been transmitted for FEC to recover without the remaining PDUs is not recommended as it might trigger an increase of FEC packets.

In uplink, the UE may be configured with PDU Set based discard operation for a specific DRB. When configured, the UE discards all packets in a PDU set when one PDU belonging to this PDU set is discarded, e.g., based on discard timer expiry. In case of congestion, the PSI may be used for PDU set discarding. In uplink, dedicated signaling may be used to trigger discard mechanism based on PSI.

Regarding configured grants (e.g., semi-persistently scheduled grants), the following enhancements for configured grant (CG)-based transmission may be implemented: A) Multiple CG PUSCH transmission occasions in a period of a single CG PUSCH configuration; B) Dynamic indication of unused CG PUSCH occasion(s) based on UCI (e.g., CG-UCI or a new UCI) by the UE.

According to aspects of a first solution, the UE starts a timer upon arrival of a PDU (of a PDU set) for a LCH which is part of a group of LCHs.

According to one implementation of first solution, the UE has a multi-modal application running consisting of ‘n’ associated traffic flows/LCHs/LCGs/DRBs (referred to as TF1, . . . , TFn). While the term “traffic flow” is used in the following descriptions, this term may be replaced by the term(s) LCH, LCG, Data Radio Bearer (DRB) in accordance with the present disclosure. In one example the traffic flows (and/or LCHs) are linked together via a multi-modal-flow coordination ID or group ID. This linking ID may also be referred to as a traffic ID.

In one implementation of the first solution, the PDU sets/PDUs of the associated traffic flows (i.e., LCHs associated with the multi-modal application) are inter-dependent, e.g., where the inter-dependent PDUs/PDU set(s) of the associated LCHs are required to be received/transmitted within a certain time window.

Upon arrival of a first PDU/PDU set of the inter-dependent PDUs/PDU sets of the associated LCHs, the UE starts a new timer which enforces the relative delay budget among the associated LCHs/flows. The new timer, also referred to as MM timer, enforces the time window during which the inter-dependent PDUs/PDUs of the associated LCHs/flows needs to be transmitted/received. In one example the MM timer is maintained in the PDCP sublayer 218, e.g., in the PDCP entity associated with the LCH for which the first PDU/PDU set of the inter-dependent PDUs/PDU sets have arrived.

In one implementation of the first solution, the UE starts a new timer which enforces the relative delay budget among the associated LCHs/flows upon arrival of the last PDU/SDU of the first PDU set of the inter-dependent PDUs/PDU sets of the associated LCHs.

FIG. 4 illustrates an example of a timing diagram 400 for enforcing a synchronization requirement for a multi-modal application in accordance with the first solution. Here, the multi-modal application (not depicted) is associated with a set of LCHs-depicted as “LCH1” 402, “LCH2” 408, and “LCH3” 412. According to a representative scenario, the set of associated LCHs is comprised of 3 LCHs corresponding to, e.g., haptic data, audio data, and video data.

As depicted, there is one relative multi-modal delay budget. Accordingly, inter-dependent data packets/PDU sets of the 3 associated LCHs need to be transmitted/received during the relative delay budget (time window).

At time t1, the PDU set (e.g., a first PDU of the PDU set) of LCH1 402 arrives in the UE buffer. As in the legacy procedure, the UE starts a PDCP discard timer 404 configured for LCH1/PDCP entity of LCHs for the PDU respectively associated PDU set. In accordance with the first solution, the new MM timer 406 is also started, in addition to the PDCP discard timer 404, where the new MM timer 406 is responsible for enforcing the relative multi-modal delay budget.

At time t2, the inter-dependent PDU set (e.g., the first PDU of the PDU set) of LCH2 408 arrives in the UE buffer. A corresponding PDCP discard timer 410 is started for the PDU/PDU set of LCH2 408—as specified in current specifications.

At time t3, the related PDU set (e.g., the first PDU of the PDU set) of LCH3 412 arrives in the UE buffer and accordingly the PDCP discard timer 414 is started for the PDU/PDU set.

However, at time t4, upon expiry of the new MM timer 406 enforcing the multi-modal relative delay requirement, the UE stops transmitting any remaining transmissions of the inter-dependent PDU sets. In other words, any remaining PDUs of the inter-dependent PDU sets of LCH1 402, LCH2 408, or LCH3 412 pending for transmission are discarded upon expiry of the MM timer 406.

In some embodiments, the MM timer 406 is started upon arrival of the first PDU/PDU set of the inter-dependent PDU sets, which could be PDU of PDU set of LCH1 402, LCH2 408, or LCH3 412, depending on the traffic characteristic and jitter. Therefore, and according to one implementation of the first solution, the UE maintains an MM timer 406 for each LCH or associated PDCP entity of the set of associated LCHs. For example, each PDCP entity of the set of associated LCHs may be configured with a respective MM timer 406 for enforcing the multi-modal synchronization requirement among the set of associated/multi-modal flows/LCHs. However, a particular MM timer 406 is only started for one LCH of the set of associated LCHs, e.g., for the LCH for which the PDU/PDU set arrived first.

In one example, the network configures the UE with the MM timer configuration, e.g., the network configures for each of the LCHs of the set of associated LCHs a MM timer. According to another exemplary implementation, the UE sets the MM timer value based on PDU set information received from the application layer, e.g., the Application layer informs the AS layer of the UE about the multi-modal relative delay requirement and the UE/PDCP entity determines the MM timer configuration/value accordingly.

According to embodiments of a second solution, the UE determines a PDCP discard timer value associated with a PDU/PDU set based on some other timer value running for same or different PDCP entity. According to one implementation of this second solution, the PDCP discard timer value associated with a PDCP PDU/SDU is a function of the configured discard timer value and the current value of a different timer (e.g., MM timer) running in the same PDCP entity or a different PDCP entity.

Accordingly, whenever the UE starts a PDCP discard timer for a PDCP SDU/PDU/PDU set which is part of a set of inter-dependent PDU sets of multi-modal LCHs/flows, the PDCP discard timer value is determined as the minimum of the configured PDCP discard timer value and the current value of the timer enforcing the multi-modal relative delay requirement.

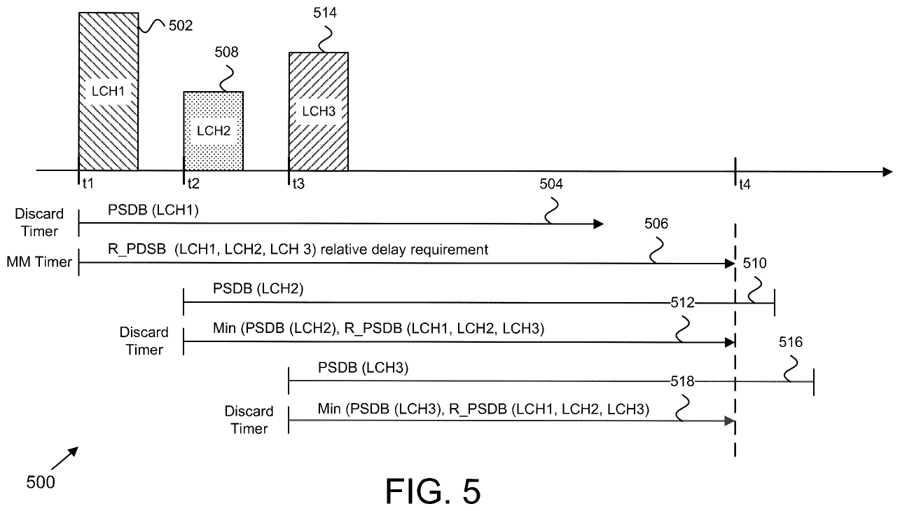

FIG. 5 illustrates another example of a timing diagram 500 for enforcing a synchronization requirement for a multi-modal application in accordance with the second solution. Here, the multi-modal application (not depicted) is associated with a set of LCHs-depicted as “LCH1” 502, “LCH2” 508, and “LCH3” 514. According to a representative scenario, the set of associated LCHs is comprised of 3 LCHs corresponding to, e.g., haptic data, audio data, and video data.

As depicted, there is one relative multi-modal delay budget. Accordingly, inter-dependent data packets/PDU sets of the 3 associated LCHs need to be transmitted/received during the relative delay budget (time window).

At time t1, the PDU set (e.g., a first PDU of the PDU set) of LCH1 502 arrives in the UE buffer. As in the legacy procedure, the UE starts a PDCP discard timer 504 configured for LCH1/PDCP entity of LCHs for the PDU respectively associated PDU set. In accordance with the second solution, a new MM timer 506 is also started, in addition to the PDCP discard timer 504, where the new MM timer 506 is responsible for enforcing the relative multi-modal delay budget.

At time t2, the inter-dependent PDU set of LCH2 508 arrives in the UE buffer. A corresponding PDCP discard timer 512 is started for the PDU/PDU set of LCH2 408—as specified in current specifications. However, the value of the PDCP discard timer is set with consideration of the current timer value of the MM timer 506 and the configured discard timer value for LCH 2 510. In one example, the value of the PDCP discard timer 512 of LCH2 508 is set as the minimum of (PDSB (LCH2), timer value of new MM timer).

At time t3, the inter-dependent PDU set of LCH3 514 arrives in UE buffer. Same as for LCH2 508, the PDCP discard timer 518 is set with consideration of the configured discard timer value for LCH 3 516 (i.e., PSDB (LCH3)) and the current value of the MM timer 506. In one example, the value of the PDCP discard timer 518 of LCH3 514 is set as the minimum of (PDSB (LCH3), timer value of new MM timer).

Accordingly, at time t4, upon expiry of the new MM timer 406 enforcing the multi-modal relative delay requirement, the PDCP discard timer 512 and the PDCP discard timer 518 also expire. Therefore, the UE stops transmitting any remaining transmissions of the inter-dependent PDU sets. In other words, any remaining PDUs of the inter-dependent PDU sets of LCH1 402, LCH2 408, or LCH3 412 pending for transmission are discarded upon expiry of the MM timer 406 and concurrent expiry of the PDCP discard timer 512 and the PDCP discard timer 518.

Therefore, according to one implementation of the second solution, the multi-modal relative delay requirement is enforced by adapting the legacy PDCP discard timer value, e.g., considering the current value of the MM timer when starting the PDCP discard timer. No specific action needs to be performed upon the expiry of the MM timer, since the PDCP discard timer(s) is/are enforcing the multi-modal relative delay requirement, e.g., discarding is performed at the expiry of the PDCP discard timer as in the legacy.

According to embodiments of a third solution, the UE starts a timer, e.g., the MM timer, upon submitting a first PDU of a PDU set to lower layer for transmission for a LCH which is part of a group of associated LCHs. According to one implementation of the third solution, the UE has a multi-modal application running consisting of ‘n’ associated traffic flows/LCHs/LCGs/DRBs (referred to as TF1, . . . , TFn). In one example, the flows or LCHs are linked together via a multi-modal-flow coordination ID or group ID.

In one implementation of the third solution, the PDU sets/PDUs of the associated traffic flows/LCHs are inter-dependent, e.g., the inter-dependent PDUs/PDU set(s) of the associated LCHs are required to be received/transmitted within a certain time window. Upon submission of a first PDU/PDU set of the inter-dependent PDUs/PDU sets of the associated LCHs, the UE starts the MM timer which enforces the relative delay budget among the associated LCHs/flows, e.g., the new timer enforces the time window during which the inter-dependent PDUs/PDUs of the associated LCHs/flows needs to be transmitted/received.

In one implementation of the third solution, the UE starts a new timer which enforces the relative delay budget among the associated LCHs/flows upon submitting the last PDU of a first PDU set to lower layer for transmission for a LCH which is part of a group of associated LCHs.

According to embodiments of a fourth solution, the UE starts a timer upon receiving an acknowledgement for the reception of a first PDU of a PDU set of a LCH which is part of a group of associated LCHs. According to one implementation of the fourth solution, the UE starts the MM timer upon successful completion of transmission of a (first) PDU (or a PDU set) from a first LCH of the ‘n’ associated LCHs. In one implementation of the fourth solution, the acknowledgement for the reception of a PDU is determined based on a DCI scheduling an initial (new) transmission for the HARQ process ID on which UE transmitted the PDU.

In one implementation of the fourth solution, the UE starts a new timer which enforces the relative delay budget among the associated LCHs/flows upon receiving an acknowledgement for the reception of the last PDU of a first PDU set of a LCH which is part of a group of associated LCHs. According to one implementation of the fourth solution, the UE starts the MM timer upon successful completion of transmission of a (first) PDU set from a first LCH of the ‘n’ associated LCHs.

According to embodiments of a fifth solution, the UE is configured for one of the LCHs comprising a set of associated LCHs with a timer enforcing the multi-modal relative delay requirement. According to one implementation of the fifth solution, the new timer (which is also referred to as the MM timer) is only configured/maintained for one of the LCHs which are in the set of associated LCHs. In one example, the LCH of the set of associated LCHs which is configured with a MM timer is the LCH carrying the highest importance data of the set of associated LCHs, e.g., LCH carrying the video frames.

In an implementation, the UE reports its capability of supporting MM-timers, and (if supporting) how many MM-timers.

According to embodiments of a sixth solution, the UE triggers the transmission of multi-modal related delay status information (also referred to as MM-DSR in the following) for cases when the timer enforcing the relative multi-modal delay budget/synchronization requirement for the group of associated flow/LCHs (also referred to as MM timer) drops below a preconfigured threshold.

For UL resource allocation, it would be necessary that UE provides some assistance information regarding the MM-related remaining delay budget of the data pending in its buffer to the gNB. In certain embodiments, the UE provides information on the remaining delay budget of the data for which UL resources are requested. Such assistance information is referred to as Delay Status reporting (DSR) reporting.

As described above, the PSDB information provided to the RAN is insufficient, therefore additional assistance information is needed. Because the network is not aware of the exact arrival time of UL data in the buffer and hence also cannot be sure about the remaining (valid) time of data being pending in the buffer for transmission, the UE provides this additional assistance information, e.g., remaining delay information, within the DSR reporting.

According to one implementation of the sixth solution, the UE provides the gNB with information about the remaining time of multi-modal data pending in the UE buffer. In one example, the UE triggers the transmission of MM-DSR if the MM timer value drops below a preconfigured threshold.

In one implementation of the sixth solution, the UE reports the remaining time of the MM-timer and information of the data volume of the inter-related data, e.g., PDUs/PDU sets, of the set of associated LCHs/flows which is pending in the UE buffer for transmission. Based on the MM-DSR information, the gNB is aware of the amount of data and the urgency of such data, e.g., gNB is aware of how much data needs to be transmitted on the UL within the reported remaining delay in order to fulfil the synchronization requirement of the associated LCHs.

According to one implementation of the sixth solution, the threshold for triggering transmission of MM-DSR is configured per multi-modal group ID, e.g., the ID identifying the set of associated bearers/LCHs/flows. In one example, the threshold is configured per multi-modal-flow coordination ID. In another example, the threshold is configured per LCG within a group of associated LCHs/bearers/flows.

According to embodiments of a seventh solution, the UE is provided with a delay requirement for a set of associated LCHs/flows. According to one implementation of the seventh solution, the UE is provided with a delay requirement, which denotes that the synchronization requirement for a set of associated LCHs/flows, e.g., for a multi-modal application being comprised of different inter-dependent LCHs/flows (e.g., Video, audio, haptic).

In one example the UE is provided by the network with a group ID, e.g., MM-flow coordination ID, and an associated inter-flow synchronization requirement (e.g., inter-flow delay budget). The inter-flow synchronization requirement/delay budget represents in one example a time window during which inter-related data of the LCHs/flows being a member of the group ID/Multi-modal-flow coordination ID needs to be transmitted or received.

According to one implementation of the seventh solution, the group ID (i.e., the ID of the set of associated flows/LCHs) and the associated inter-flow synchronization requirement is provided by the network to the UE. In one example, the Application layer provides the information to the access stratum of the UE, e.g., to the PDCP layer.

According to one implementation of the seventh solution, the multi-modal related QoS information may be provided by the SMF to the gNB, e.g., QoS information for a group of associated QoS flows/LCHs like group ID and the associated inter-flow synchronization requirements.

According to one implementation of the seventh solution, the UE is provided with information about inter-related PDU sets of LCHs being part of a set of associated flows/LCHs. In one example, the UE is provided with information on the PDU set sequence numbers of the inter-related PDU set of associated LCHs.

In one exemplary implementation, the UE is provided with the sequence numbers of the PDU set(s) of a first LCH and the sequence number of the inter-related PDU set(s) of the associated LCHs. For example, the following information may be given to the access stratum of the UE: PDU set with serial number (SN) 1 is related with PDU sets having SN 1,2 of LCH2 and PDU sets with SN 1,2,3 of LCH 3. This would indicate to the UE that one PDU set of LCHs is inter-related with two PDU sets of LCH2 and 3 PDU sets of LCH3.

The inter-relation will continue accordingly with the a given periodicity, e.g., PDU set SN=2 of LCH1 is inter-related with PDU set SN=3,4 of LCH 2 and PDU set SN=4,5,6 of LCH 3 etc. In one example, the information about inter-related PDU sets is given to the AS of the UE by the Application, e.g., left to UE implementation how the information is to be provided.

According to one implementation of the seventh solution, information about inter-related PDU sets of associated LCHs/flows may be provided by the SMF to the gNB, e.g., QoS information for a group of associated QoS flows/LCHs.

According to embodiments of an eighth solution, the network explicitly enables/disables a transmission mode in the UE for specific XR applications, e.g., multi-modal transmission mode. According to one implementation of the eighth solution, the UE in response to receiving control information enabling the multi-modal transmission mode, enforces the synchronization requirements (multi-modal relative delay requirements) e.g., by using the MM timer or enabling MM-DSR reporting.

In one example, the UE performs an enhanced logical channel prioritization (LCP) procedure for cases that multi-modal transmission mode is enabled, e.g., LCP procedure considers in addition to the LCH priority also the relative delays between inter-related PDU set(s) of different associated LCHs into account.

According to one implementation of the eighth solution, the network enables or disables the multi-modal transmission mode by means of MAC control element signaling. According to one implementation of the eighth solution, the new signaling enabling/disabling multi-modal transmission mode is comprised of at least one identifier identifying the group of associated flows/LCHs/bearers for which multi-modal transmission is enabled or disabled, e.g., the group ID or multi-modal-flow coordination ID.

In one example the new signaling is comprised of a one-bit field which is present per group ID, indicating whether the multi-modal transmission mode is enabled or disabled. In one example the field set to ‘0’ indicates that the multi-modal transmission mode is disabled, whereas the field set to ‘1’ indicates that the multi-modal transmission mode is enabled for the corresponding group ID, e.g., the set of associated bearers/flows/LCHs identified by the group ID.

According to embodiments of a ninth solution, the network configures a relative priority for each of the LCHs which belong to a set of associated LCHs. According to one implementation of the embodiment the relative priority represents the relative importance of the different flows/LCHs within the group of associated LCHs/flows, e.g., Video might be the most important modality of an XR multi-modal application, followed by audio and haptic.

In one specific implementation, one LCH of the set of associated LCHs, e.g., identified by a group ID, might be configured as the primary LCH. In one example certain characteristics/functionalities are associated with the relative priority of the LCH of a set of associated LCHs. For example, in case of discarding PDU set(s) due to not fulfilling the multi-modal synchronization requirements, the application might still benefit from receiving at least the video frames or some other sensor data, e.g., highest priority LCH/flow within the set of associated flows/LCHs. Therefore, the discarding function might take into account the relative priority/priority order associated with the LCHs of a set of associated LCHs, e.g., for determining what kind of data to discard.

In an example, such relative priority is determined based on the relative delay budget amongst pairs of associated LCHs. For instance, if the relative delay budget between {(A→H), (H→A), (V→H), (H→V)} is respectively, (50, 25, 15, 50) ms, then, video has the highest relative priority followed by haptic, and then audio (considering 15 ms, 25 ms, and then 50 ms respective delays); wherein, e.g., (A→H) represents the maximum tolerable relative delay of audio traffic flow if delayed compared to haptic traffic flow.

According to one implementation of the ninth solution, the UE is explicitly configured with a configuration indicating what data to discard in the case that the multi-modal synchronization requirements are not fulfilled. In one example the configuration is indicating the LCHs of the set of associated LCHs for which data should be discarded when the multi-modal synchronization is not fulfilled, such as when the MM timer is expiring.

According to embodiments of a tenth solution, the multi-modal delay status report, e.g., also referred to as MM-DSR, is comprised of a delay status field indicating a remaining delay info and data volume information. According to one implementation of the tenth solution, the data volume information contains the amount of data across the set of associated LCHs/bearers/flows being associated with the signaled remaining delay budget, e.g., the amount of data of the inter-dependent PDU set(s) of the associated LCHs pending for transmission being associated with the remaining delay budget, e.g., being associated with the corresponding Multi-modal timer. The remaining delay info represents the remaining time left for fulfilling the multi-modal synchronization delay requirement, e.g., current value of the MM timer.

In one example the MM-DSR contains an identity identifying the group of associated flows/LCHs/bearers (e.g., multi-modal-flow coordination ID) for which the delay status and data volume information is reported.

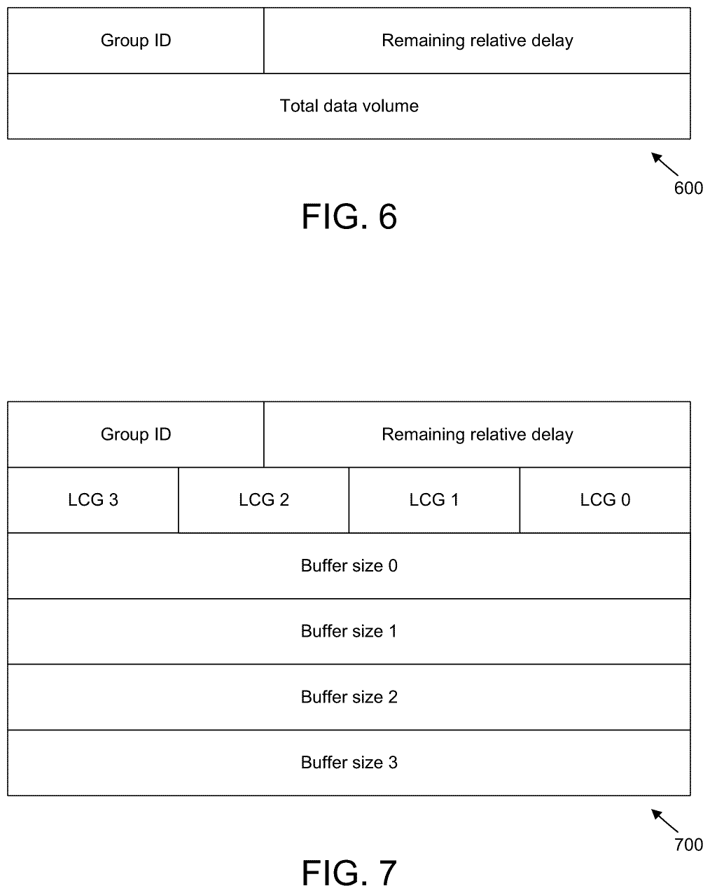

FIG. 6 illustrates an example of a MAC CE format 600 for MM-DSR in accordance with aspects of the present disclosure, where total data volume across all LCGs within one group of associated LCHs is reported.

In one example the data volume associated with the reported remaining delay info is reported per LCG, e.g., the MM-DSR contains for each LCG belonging to group of associated LCHs a field indicating the amount of data of the inter-related PDU set(s) pending for transmission and a field identifying the LCG (LCG ID).

FIG. 7 illustrates another example of a MAC CE format 700 for a MM-DSR in accordance with aspects of the present disclosure, where data volume is reported per LCG belonging to a group of associated LCHs.

According to embodiments of an eleventh solution, UE is provided with an offset which is to be applied by the UE for PDU sets having a low(er) importance when PSI based discarding is enabled. According to one implementation of the eleventh solution, UE considers in addition to the PDCP discard timer value the configured offset when determining whether to discard a PDU/PDU set which is categorized as an PDU/PDU set of low(er) importance. In order to allow for a faster discarding of low importance PDUs/PDU sets for cases when the UL air interface is congested, e.g., PSI-based discarding is enabled by the NW, UE considers the discard timer value of a PDU as expires when the current discard timer value is equal to the configured offset. In one example the offset is configured, e.g., for a PDCP entity, to be 5 ms. The PDCP discard timer value is set to 15 ms. For cases that NW enables PSI based discarding, UE considers the PDCP discard timer for low importance PDU/PDU sets as expired and does the corresponding discarding action 10 ms after the PDCP discard timer has been started, e.g., when the discard timer reaches a value of 5 ms. In one example implementation of the solution the categorization of PDU/PDU sets into important and low important PDU/PDU sets is done by UE implementation. The configured offset has from discarding perspective the same effect as adjusting/reconfiguring the PDCP discard timer to a shorter value, e.g., setting it to a 5 ms shorter value in the example. However, since the actual PDCP discard timer value is not changed according to the embodiment, the DSR reporting is not impacted by this solution, e.g., DSR reporting is triggered according to the (unchanged) PDCP discard timer.

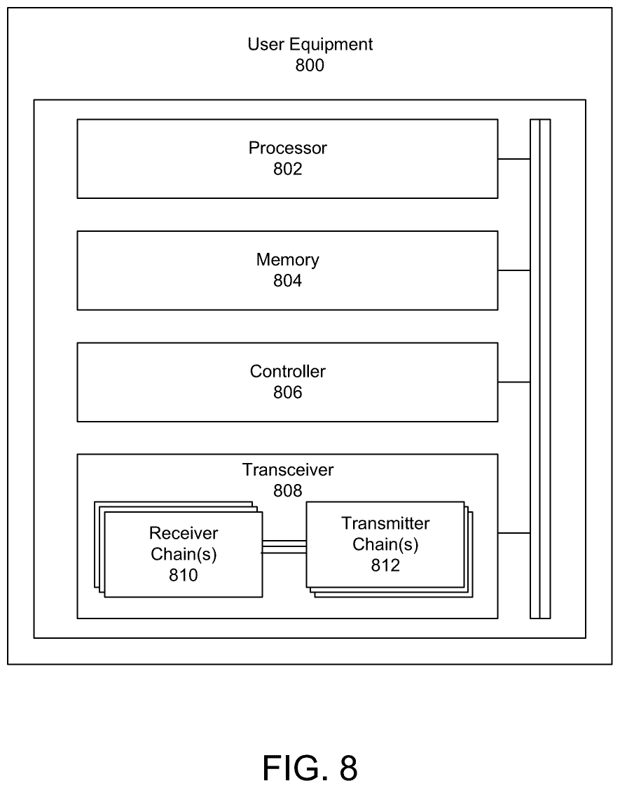

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a central processing unit (CPU), an ASIC, a field programmable gate array (FPGA), or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions that, when executed by the processor 802, cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the UE functions described herein (e.g., executing, by the processor 802, instructions stored in the memory 804). Accordingly, the processor 802 may support wireless communication at the UE 800 in accordance with examples as disclosed herein. For example, the UE 800 may be configured to support a means for receiving a traffic ID (e.g., MM-flow coordination ID or MM group ID) for a MM traffic flow, where the multi-modal traffic flow comprises a plurality of LCHs associated with the same multi-model application.

The UE 800 may be configured to support a means for initiating an MM timer associated with a first LCH based on an arrival of a first data packet of the first LCH, where the first LCH is associated with the traffic ID. In some implementations, the UE 800 is configured to start the MM timer in response to the MM timer not running upon arrival of the first data packet. In some embodiments, the UE 800 is configured to start the MM timer in response to receipt of an acknowledgement of successful reception of the first data packet.

In some embodiments, the UE 800 is configured to set a value of the MM timer based on PDU set information received from an application layer of the UE. In some embodiments, the UE 800 is configured to receive a configuration message for configuring a set of MM timers.

The UE 800 may be configured to support a means for identifying an inter-dependent data packet set based on the traffic ID, where the inter-dependent data packet set comprises the first data packet and at least one second data packet of a second LCH associated with the traffic ID.

In some embodiments, the UE 800 is configured to start a discard timer in response to an arrival of a respective second data packet of the second LCH, and where expiry of the MM timer triggers the UE to override the discard timer and to discard the second data. In some embodiments, the UE 800 is configured to start a discard timer in response to an arrival of a respective second data packet of the second LCH, where a value of the discard timer is based on the MM timer, and where the MM timer and the discard timer expire simultaneously.

The UE 800 may be configured to support a means for applying a relative delay requirement to the inter-dependent data packet set based on the MM timer. In some embodiments, to apply the relative delay requirement, the UE 800 may be configured to stop transmitting a remaining transmission of the inter-dependent data packet set in response to expiry of the MM timer.

In some embodiments, to apply the relative delay requirement, the UE 800 may be configured to track a relative latency budget associated with a delivery of the at least one second data packet with respect to a delivery of the first data packet, and to report the relative latency budget in a DSR. In some embodiments, to apply the relative delay requirement, the UE 800 may be configured to transmit an MM-DSR in response to the MM timer satisfying a threshold value.

In certain embodiments, to transmit the MM-DSR the UE 800 may be configured to transmit a MAC CE comprising the MM-DSR. In one embodiment, the MM-DSR indicates a total data volume for each LCH associated with the traffic ID. In another embodiment, the MM-DSR indicates a data volume per LCH group (LCG) associated with the traffic ID.

The controller 806 may manage input and output signals for the UE 800. The controller 806 may also manage peripherals not integrated into the UE 800. In some implementations, the controller 806 may utilize an operating system (OS) such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding/processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

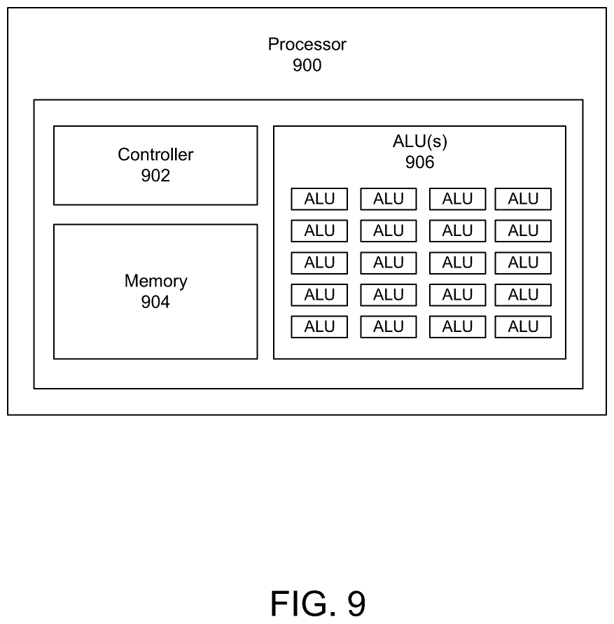

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

In various embodiments, the processor 900 may support wireless communication of a UE in accordance with examples as disclosed herein. For example, the processor 900 may be configured to support a means for receiving a traffic ID (e.g., MM-flow coordination ID or MM group ID) for a MM traffic flow, where the multi-modal traffic flow comprises a plurality of LCHs associated with the same multi-model application.

The processor 900 may be configured to support a means for initiating an MM timer associated with a first LCH based on an arrival of a first data packet of the first LCH, where the first LCH is associated with the traffic ID. In some implementations, the processor 900 is configured to start the MM timer in response to the MM timer not running upon arrival of the first data packet. In some embodiments, the processor 900 is configured to start the MM timer in response to receipt of an acknowledgement of successful reception of the first data packet.

In some embodiments, the processor 900 is configured to set a value of the MM timer based on PDU set information received from an application layer of the UE. In some embodiments, the processor 900 is configured to receive a configuration message for configuring a set of MM timers.

The processor 900 may be configured to support a means for identifying an inter-dependent data packet set based on the traffic ID, where the inter-dependent data packet set comprises the first data packet and at least one second data packet of a second LCH associated with the traffic ID.

In some embodiments, the processor 900 is configured to start a discard timer in response to an arrival of a respective second data packet of the second LCH, and where expiry of the MM timer triggers the UE to override the discard timer and to discard the second data. In some embodiments, the processor 900 is configured to start a discard timer in response to an arrival of a respective second data packet of the second LCH, where a value of the discard timer is based on the MM timer, and where the MM timer and the discard timer expire simultaneously.

The processor 900 may be configured to support a means for applying a relative delay requirement to the inter-dependent data packet set based on the MM timer. In some embodiments, to apply the relative delay requirement, the processor 900 may be configured to stop transmitting a remaining transmission of the inter-dependent data packet set in response to expiry of the MM timer.

In some embodiments, to apply the relative delay requirement, the processor 900 may be configured to track a relative latency budget associated with a delivery of the at least one second data packet with respect to a delivery of the first data packet, and to report the relative latency budget in a DSR. In some embodiments, to apply the relative delay requirement, the processor 900 may be configured to transmit an MM-DSR in response to the MM timer satisfying a threshold value.

In certain embodiments, to transmit the MM-DSR the processor 900 may be configured to transmit a MAC CE comprising the MM-DSR. In one embodiment, the MM-DSR indicates a total data volume for each LCH associated with the traffic ID. In another embodiment, the MM-DSR indicates a data volume per LCH group (LCG) associated with the traffic ID.

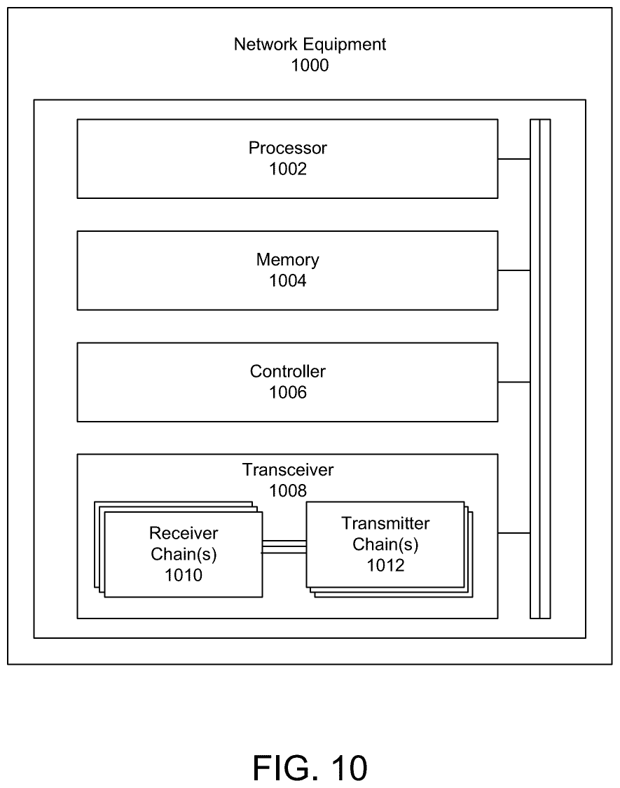

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the RAN functions described herein (e.g., executing, by the processor 1002, instructions stored in the memory 1004). For example, the processor 1002 may support wireless communication at the NE 1000 in accordance with examples as disclosed herein.

The NE 1000 may be configured to support a means for transmitting, to a UE, a traffic ID for a MM traffic flow, where the MM traffic flow comprises a plurality of LCHs associated with an MM application. The NE 1000 may be configured to support a means for transmitting, to the UE, a configuration message for configuring a set of MM timers.

The NE 1000 may be configured to support a means for receiving, from the UE, a status message indicating a relative delay requirement of an inter-dependent data packet set based on a respective MM timer of the set of MM timers, wherein the inter-dependent data packet set is associated with the traffic ID. In some implementations, to receive the status message, the NE 1000 is further configured to receive a DSR indicating a relative latency budget associated with a delivery of the at least one second data packet with respect to a delivery of a first data packet.

In some implementations, the NE 1000 may be configured to receive the status message, the at least one processor is further configured to cause the base station to receive a MAC CE comprising an MM-DSR. In certain embodiments, the MM-DSR indicates a total data volume for each LCH associated with the traffic ID. In certain embodiments, the MM-DSR indicates a data volume per LCG associated with the traffic ID.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding/processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

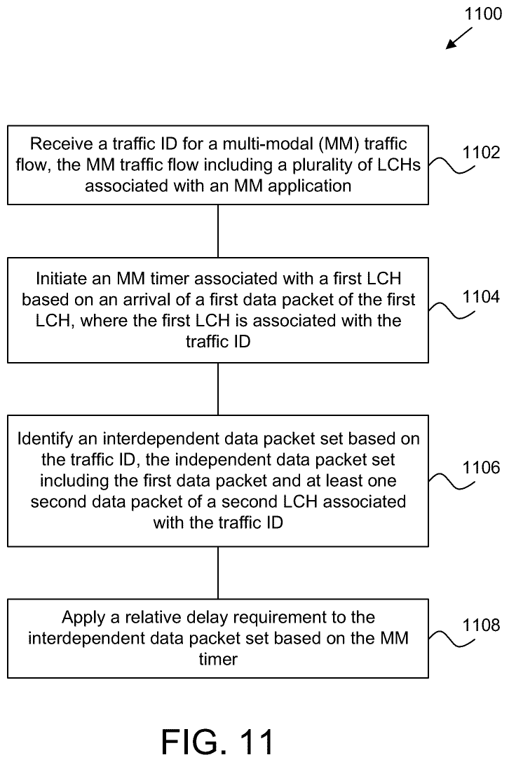

FIG. 11 illustrates a flowchart of a method 1100 performed by a UE in accordance with aspects of the present disclosure. The operations of the method 1100 may be implemented by a UE as described herein. In some implementations, the UE may execute a set of instructions to control the function elements of the UE to perform the described functions.

At step 1102, the method 1100 may include receiving a traffic ID for a MM traffic flow, where the multi-modal traffic flow comprises a plurality of LCHs associated with a multi-model application. The operations of step 1102 may be performed in accordance with examples as described herein. In some implementations, aspects of the operations of step 1102 may be performed by a UE, as described with reference to FIG. 8.

At step 1104, the method 1100 may include initiating an MM timer associated with a first LCH based on an arrival of a first data packet of the first LCH, where the first LCH is associated with the traffic ID. The operations of step 1104 may be performed in accordance with examples as described herein. In some implementations, aspects of the operations of step 1104 may be performed by a UE, as described with reference to FIG. 8.

At step 1106, the method 1100 may include identifying an inter-dependent data packet set based on the traffic ID, where the inter-dependent data packet set comprises the first data packet and at least one second data packet of a second LCH associated with the traffic ID. The operations of step 1106 may be performed in accordance with examples as described herein. In some implementations, aspects of the operations of step 1106 may be performed by a UE, as described with reference to FIG. 8.

At step 1108, the method 1100 may include applying a relative delay requirement to the inter-dependent data packet set based on the MM timer. The operations of step 1108 may be performed in accordance with examples as described herein. In some implementations, aspects of the operations of step 1108 may be performed by a UE, as described with reference to FIG. 8.

It should be noted that the method 1100 described herein describes one possible implementation, and that the operations and the steps may be rearranged or otherwise modified and that other implementations are possible.

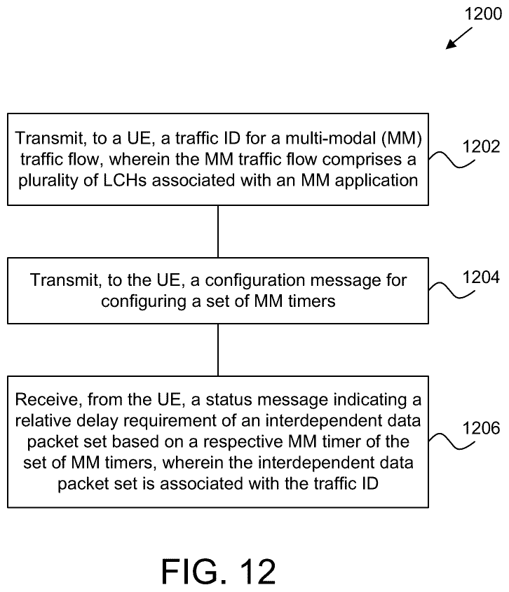

FIG. 12 illustrates a flowchart of a method 1200 performed by a RAN entity in accordance with aspects of the present disclosure. In various embodiments, the operations of the method 1200 may be implemented by a RAN as described herein. In some implementations, the RAN may execute a set of instructions to control the function elements of the RAN to perform the described functions.

At step 1202, the method 1200 may include transmitting, to a UE, a traffic ID for a MM traffic flow, where the MM traffic flow comprises a plurality of LCHs associated with a MM application. The operations of step 1202 may be performed in accordance with examples as described herein. In some implementations, aspects of the operation of step 1202 may be performed by a NE, as described with reference to FIG. 10.

At step 1204, the method 1200 may include transmitting, to the UE, a configuration message for configuring a set of MM timers. The operations of step 1204 may be performed in accordance with examples as described herein. In some implementations, aspects of the operation of step 1204 may be performed by a NE, as described with reference to FIG. 10.

At step 1206, the method 1200 may include receiving, from the UE, a status message indicating a relative delay requirement of an inter-dependent data packet set based on a respective MM timer of the set of MM timers, where the inter-dependent data packet set is associated with the traffic ID. The operations of step 1206 may be performed in accordance with examples as described herein. In some implementations, aspects of the operation of step 1206 may be performed by a NE, as described with reference to FIG. 10.

It should be noted that the method 1200 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a traffic identifier (ID) for a multi-modal (MM) traffic flow, wherein the MM traffic flow comprises a plurality of logical channels (LCHs) associated with an MM application;
initiate an MM timer associated with a first LCH based on an arrival of a first data packet of the first LCH, wherein the first LCH is associated with the traffic ID;
identify an inter-dependent data packet set based on the traffic ID, wherein the inter-dependent data packet set comprises the first data packet and at least one second data packet of a second LCH associated with the traffic ID; and
apply a relative delay requirement to the inter-dependent data packet set based on the MM timer.

2. The UE of claim 1, wherein to apply the relative delay requirement, the at least one processor is further configured to cause the UE to:
track a relative latency budget associated with a delivery of the at least one second data packet with respect to a delivery of the first data packet; and
report the relative latency budget in a delay status report (DSR).

3. The UE of claim 1, wherein to apply the relative delay requirement, the at least one processor is further configured to cause the UE to transmit an MM delay status report (MM-DSR) in response to the MM timer satisfying a threshold value.

4. The UE of claim 3, wherein to transmit the MM-DSR, the at least one processor is configured to cause the UE to transmit a medium access control (MAC) control element (CE) comprising the MM-DSR.

5. The UE of claim 3, wherein the MM-DSR indicates a total data volume for each LCH associated with the traffic ID.

6. The UE of claim 3, wherein the MM-DSR indicates a data volume per LCH group (LCG) associated with the traffic ID.

7. The UE of claim 1, wherein to apply the relative delay requirement, the at least one processor is further configured to cause the UE to stop transmitting a remaining transmission of the inter-dependent data packet set in response to expiry of the MM timer.

8. The UE of claim 1, wherein the at least one processor is configured to cause the UE to start a discard timer in response to an arrival of a respective second data packet of the second LCH, and wherein expiry of the MM timer triggers the UE to override the discard timer and to discard the second data.

9. The UE of claim 1, wherein the at least one processor is configured to cause the UE to start a discard timer in response to an arrival of a respective second data packet of the second LCH, wherein a value of the discard timer is based on the MM timer, and wherein the MM timer and the discard timer expire simultaneously.

10. The UE of claim 1, wherein the at least one processor is configured to cause the UE to start the MM timer in response to the MM timer not running upon arrival of the first data packet.

11. The UE of claim 1, wherein the at least one processor is configured to cause the UE to start the MM timer in response to receipt of an acknowledgement of successful reception of the first data packet.

12. The UE of claim 1, wherein the at least one processor is configured to cause the UE to set a value of the MM timer based on Protocol Data Unit (PDU) set information received from an application layer of the UE.

13. The UE of claim 1, wherein the at least one processor is configured to cause the UE to receive a configuration message for configuring a set of MM timers.

14. A processor for wireless communication, comprising:
at least one controller coupled with at least one memory and configured to cause the processor to:
receive a traffic identifier (ID) for a multi-modal (MM) traffic flow, wherein the MM traffic flow comprises a plurality of logical channels (LCH) associated with an MM application;
initiate an MM timer associated with a first LCH based on an arrival of a first data packet of the first LCH, wherein the first LCH is associated with the traffic ID;
identify an inter-dependent data packet set based on the traffic ID, wherein the inter-dependent data packet set comprises the first data packet and at least one second data packet of a second LCH associated with the traffic ID; and
apply a relative delay requirement to the inter-dependent data packet set based on the MM timer.

15. A base station for wireless communication, comprising:
at least one memory; and
at least one processor coupled with the at least one memory and configured to cause the base station to:
transmit, to a user equipment (UE), a traffic identifier (ID) for a multi-modal (MM) traffic flow, wherein the MM traffic flow comprises a plurality of logical channels (LCHs) associated with an MM application;
transmit, to the UE, a configuration message for configuring a set of MM timers; and
receive, from the UE, a status message indicating a relative delay requirement of an inter-dependent data packet set based on a respective MM timer of the set of MM timers, wherein the inter-dependent data packet set is associated with the traffic ID.

16. The base station of claim 15, wherein to receive the status message, the at least one processor is further configured to cause the base station to receive a delay status report (DSR) indicating a relative latency budget associated with a delivery of the at least one second data packet with respect to a delivery of a first data packet.

17. The base station of claim 15, wherein to receive the status message, the at least one processor is further configured to cause the base station to receive a medium access control (MAC) control element (CE) comprising an MM delay status report (MM-DSR).

18. The base station of claim 17, wherein the MM-DSR indicates a total data volume for each LCH associated with the traffic ID.

19. The base station of claim 17, wherein the MM-DSR indicates a data volume per LCH group (LCG) associated with the traffic ID.

20. A method performed by a base station, the method comprising:
transmitting, to a user equipment (UE), a traffic identifier (ID) for a multi-modal (MM) traffic flow, wherein the MM traffic flow comprises a plurality of logical channels (LCHs) associated with a MM application;
transmitting, to the UE, a configuration message for configuring a set of MM timers; and
receiving, from the UE, a status message indicating a relative delay requirement of an inter-dependent data packet set based on a respective MM timer of the set of MM timers, wherein the inter-dependent data packet set is associated with the traffic ID.
